(19) United States
(12) Patent Application Publication
(10) Pub. No.: US 2008/0239494 A1
(43) Pub. Date: Oct. 2, 2008

(54) Tunable Light Filter

(76) Inventor: Dennis R. Zander, Penfield, NY (US)

Correspondence Address: JAECKLE FLEISCHMANN & MUGEL, LLP, 190 Linden Oaks, ROCHESTER, NY, 14625-2812, US

(21) Appl. No.: 12/063,861

(22) PCT Filed: Aug. 16, 2006
(86) PCT No.: PCT/US06/32071

§ 371 Date: Feb. 15, 2008

Related U.S. Application Data
(60) Provisional application No. 60/708,476, filed on Aug. 16, 2005.

(51) Int. Cl. G02B 5/28; G02B 26/00

(52) U.S. Cl. 359/578

(57) ABSTRACT

A tunable light filter has a transparent plate, a first mirror surface coupled to the transparent plate, and a base spaced from the transparent plate and defining a flexible base region. The flexible base region has at least one cell and a membrane coupled over the at least one cell. The flexible base region also has a second mirror surface coupled to the membrane. The tunable light filter also has an actuator which can move the second mirror surface relative to the first mirror surface. Methods of manufacturing a tunable light filter are also discussed.

### RELATED APPLICATIONS

This application claims priority to a previously filed U.S. provisional patent application No. 60/708,476, entitled, “MEMS TUNABLE FILTERS AND METHODS THEREOF”, filed on Aug. 16, 2005, which is hereby officially incorporated by reference in its entirety.

### GOVERNMENT RIGHTS

The claimed invention was made with government support under Grant NAG3-2744 awarded by NASA. The government has certain rights in the claimed invention.

### FIELD

The claimed invention generally relates to light filters, and more particularly relates to micro electrical mechanical system (MEMS) tunable light filters and methods thereof.

### BACKGROUND

Light filters selectively allow light of different wavelengths to pass through them. One type of an optical filter is the Fabry-Perot filter, an example of which is schematically illustrated by FIG. 1. The Fabry-Perot filter 20 has a first mirror surface 22 and a second mirror surface 24 separated by a distance D. A light source 26 directs incident light 28 towards the filter 20. The lights source 26 can be an optical system, one or more lenses, one or more reflective surfaces, one or more optic fibers, or any combination thereof which directs or generates incident light 28 towards the filter 20. In other embodiments, there might not need to be anything directing the incident light 28 towards the filter 20. The filter 20 could just be oriented to collect incident light 28 from any light source 26. Some of the incident light 28 will be reflected 30 by the first mirror surface 22. Some of the incident light 28 will pass through the first mirror surface 22 to become internal light 32. Some of the internal light 32 will be reflected 34 by the second mirror surface 24. Finally, some of the internal light 32 will pass through the second mirror surface 24 and can be considered output light 36. As a rule of thumb, it has been discovered that the Fabry-Perot filter 20 will allow wavelengths of light to pass which are twice the distance D which the mirror surfaces 22, 24 are spaced apart by. The majority of the remaining wavelengths are reflected by the first and second mirror surfaces 22, 24 and not allowed to pass. Fabry-Perot filters can be designed with different distances D between the mirror surfaces 22, 24 to allow a desired wavelength of light to pass through.

Some Fabry-Perot filters have been built so that the distance D between the mirror surfaces 22, 24 is adjustable, and therefore those filters are considered tunable light filters, because the desired wavelength of light which passes through 36 may be selected. A prior art example of a tunable Fabry-Perot filter 38 which can be fabricated using MEMS technology is schematically illustrated in FIG. 2. This filter 38 has a first silicon layer 40 which defines a frame 42 that supports a first membrane 44. A mirror surface 46 is coated onto the membrane 44. This example of a Fabry-Perot tunable filter 38 also has a second silicon layer 48 which is coupled by a membrane 52 another frame 50 that supports a portion of the second membrane 52. Another mirror surface 54 is coated onto the membrane 52. The first assembly 56 and the second assembly 58 are coupled together by spacers 60. Upper electrodes 62 are coated on the membrane 52. Lower electrodes 64 are coated on the membrane 44. An electrical bias may be applied to the upper electrodes 62 relative to the lower electrodes 64 to create an electrostatic attraction between the electrodes 62, 64. Since the frame 50 is moveable relative to the base 40 by flexing membrane 52, the electrostatic attractive force will tend to pull the frame 50 towards the base 40. The electrostatic force can be varied by varying the bias voltages on the electrodes 62, 64, and as the electrostatic force varies the distance between the mirror surfaces 46, 54 will vary. As discussed previously, the distance between the mirror surfaces determines which wavelengths are allowed to pass through the filter. In the prior art example of FIG. 2, the frame 50, coupled by the membrane to the silicon layer 48, is necessarily bulky to provide enough support to keep the membrane 52 and therefore the mirror 54 flat. It is desirable to keep the mirror surfaces flat, since a Fabry-Perot filter will have a higher output intensity at a narrower wavelength band when the mirror surfaces are kept both flat and parallel.

The bulky frame around the mirror membranes in the prior art device adds mass which affects how quickly the tuned-wavelength of the filter may be changed. This can be a hindrance when the filter is used in high-speed switching, multiplexing, or sampling applications. Because the membranes must be very thin, the frames have been limited to sizes around 2×2 millimeters. This limits their use with light sources or optical paths having an aperture at the location of the filter which is larger than that size. Large area Fabry-Perot filters have been constructed using mirrors coated on even more bulky solid glass plates which are moved by piezo electric actuators. While the glass plates ensure that the mirror surfaces are kept flat, such construction is very expensive, and the added mass makes the filters bulky and therefore slow to adjust due to their mass.

Therefore, it would be desirable to have a reliable high-speed tunable light filter that could be constructed economically using MEMS technology while enabling a large field area.

### SUMMARY

A tunable light filter has a transparent plate, a first mirror surface coupled to the transparent plate, and a base spaced from the transparent plate and defining a flexible base region. The flexible base region has at least one cell and a membrane coupled over the at least one cell. The flexible base region also has a second mirror surface coupled to the membrane. The tunable light filter also has an actuator which can move the second mirror surface relative to the first mirror surface.

An optical device has at least one optical input, at least one optical output, and a tunable light filter. The tunable light filter of the optical device has a transparent plate configured to receive the at least one optical input. The tunable light filter of the optical device also has a first mirror surface coupled to the transparent plate. The tunable light filter of the optical device also has a base spaced from the transparent plate and defining a flexible base region. The flexible base region has at least one cell and a membrane coupled over the at least one cell. The flexible base region also has a second mirror surface coupled to the membrane and configured to output light to the at least one optical output. The tunable light filter of the optical device also has an actuator which can move the second mirror surface relative to the first mirror surface such that the majority of light passing to the optical output has a wavelength which is approximately twice a distance between the first mirror surface and the second mirror surface as set by the actuator.

A method of manufacturing a tunable light filter is shown. A first mirror surface is coupled to a transparent plate. A flexible base region is formed in a base. At least one cell is formed in the flexible base region. A membrane is coupled over the at least one cell. A second mirror surface is coupled to the membrane over the at least one cell. The transparent plate is coupled to the base such that the first mirror surface and the second mirror surface are adjustably spaced apart, substantially parallel to each other, and such that they at least partially overlap.

### BRIEF DESCRIPTION OF THE DRAWINGS

FIG. 1 schematically illustrates a Fabry-Perot light filter.

FIG. 2 schematically illustrates a prior art embodiment of a Fabry-Perot light filter.

FIGS. 3A-3C schematically illustrate embodiments of a tunable light filter.

FIG. 4 illustrates an exploded perspective view of an embodiment of a tunable light filter.

FIG. 5 illustrates an opened-up perspective view of the tunable light filter embodiment from FIG. 4 when partially assembled.

FIG. 6 illustrates an assembled perspective view of the tunable light filter embodiment from FIG. 4.

FIG. 7 illustrates a front see-through view of the tunable light filter embodiment from FIG. 4 when assembled.

FIG. 8 illustrates a cross-sectional view of the tunable light filter embodiment from FIG. 4 when assembled as taken along cross-section line A-A from FIG. 7.

FIG. 9 illustrates an exploded perspective view of another embodiment of a tunable light filter.

FIG. 10 illustrates an opened-up perspective view of the tunable light filter embodiment from FIG. 9 when partially assembled.

FIG. 11 illustrates a front see-through view of another embodiment of a tunable light filter.

FIGS. 12A-12N, 13A-13C, and 14 schematically illustrate an embodiment of a process which may be used to fabricate a tunable light filter.

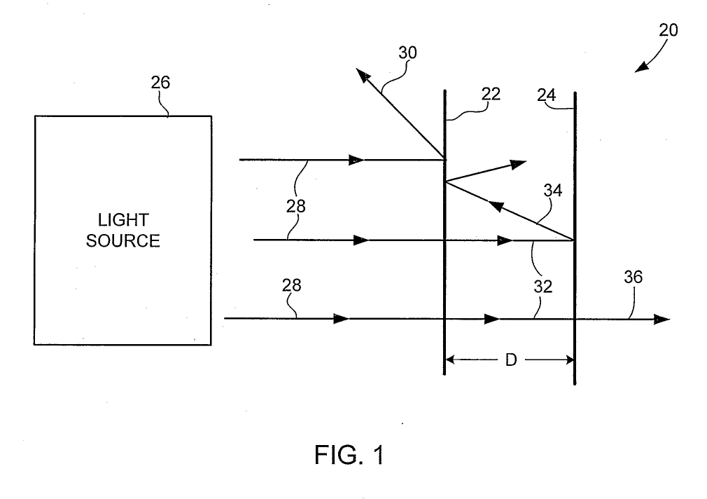

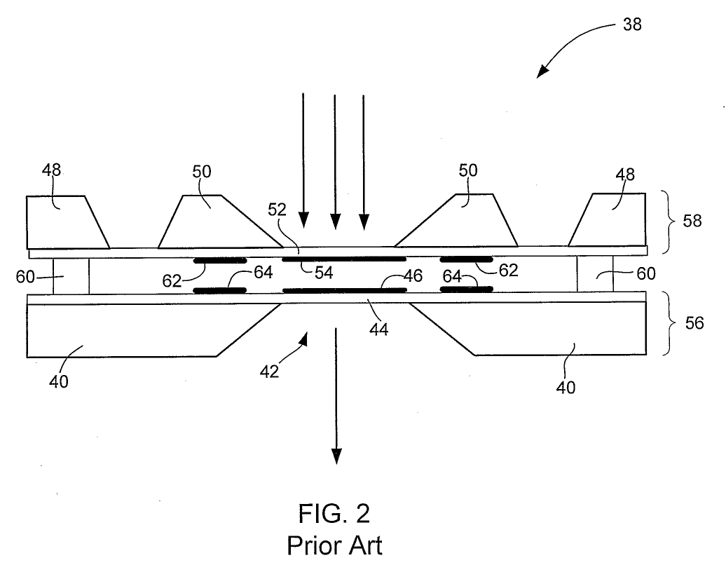

### DETAILED DESCRIPTION

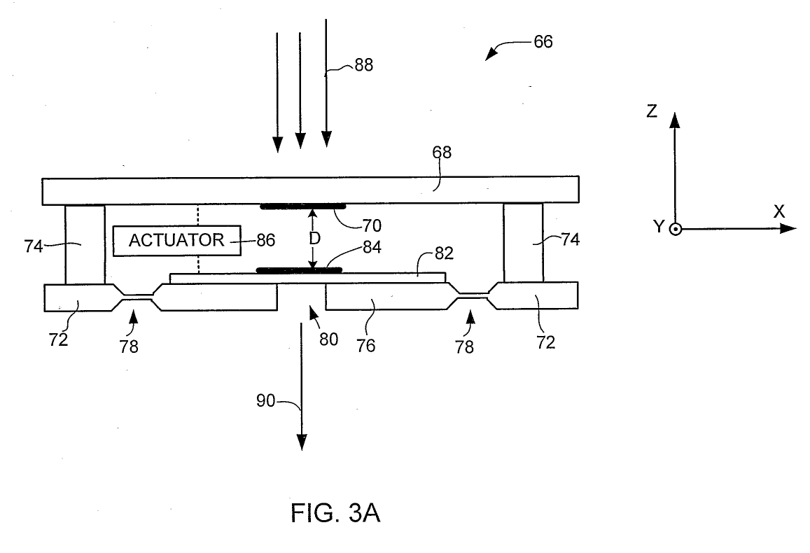

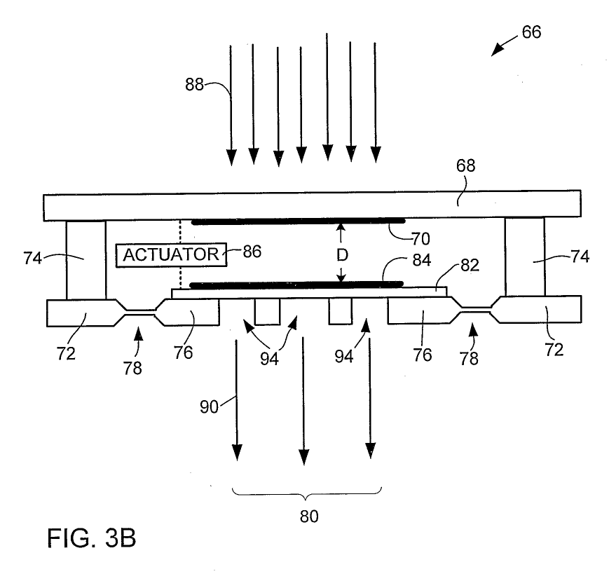

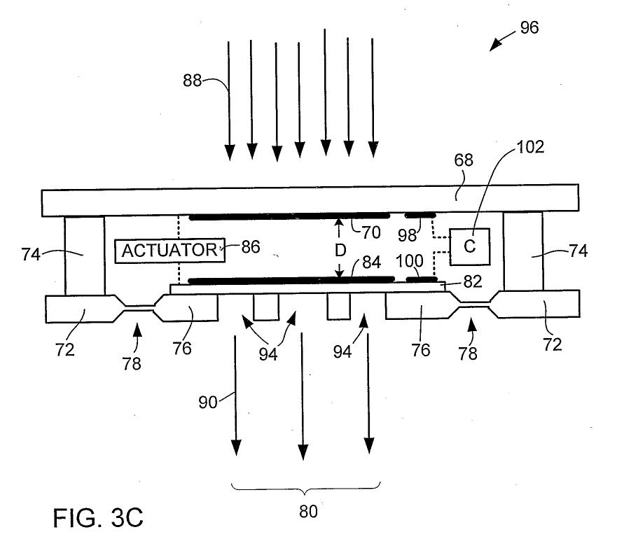

FIG. 3A schematically illustrates an embodiment of a tunable light filter 66. The tunable light filter 66 has a transparent plate 68, which may be made, for example, from glass, Plexiglas, plastic, or quartz. The transparent plate 68 may be completely or partially transparent. A first mirror surface 70 is coupled to the transparent plate 68. The first mirror surface may be, for example, silver, aluminum, gold, or other highly reflective metals. The mirror thickness is typically on the order of ¼ the target filter pass wavelength. In the case of a tunable light filter, the mirror surface thickness can be set at a ¼ wavelength thickness based on the center wavelength of a range of wavelengths expected to be passed through the filter, depending on the spacing of the mirror surfaces in the filter. Other embodiments may have other mirror surface thicknesses, and the thickness of the mirror surface is not intended to be limiting to the claimed invention. Rather than a metallic mirror surface, a Bragg-stack mirror may be coupled to the glass instead. A Bragg stack mirror can be made from a multi-layered alternating stack of high index of refraction and low index of refraction thin films. Each film is ¼ wavelength thick, based on the desired center wavelength. More layers can give a sharper-edged filter, at the expense of having a thicker mirror which reduces the output light intensity. Bragg-stack mirrors are well-known by those sldlled in the optical arts and may be adapted for use as a mirrored surface in some embodiments depending on the specifications thereof.

The tunable light filter 66 also has a base 72 spaced from the transparent plate 68 by at least one fixed spacer 74. The base 72 may be constructed using MEMS techniques, and therefore silicon is a possible choice for the base 72 material. Other materials, or even doped silicon material may be used for the base 72. The base 72 defines a flexible base region 76 which is flexibly supported by the base 72. The flexible base region 76 is not necessarily flexible itself, but it is flexible or moveable in relation to the base 72. FIG. 3A schematically illustrates the flexible base region 76 as being coupled to the base 72 by a thin area 78 that has been thinned along the plane defined by the Z-axis and the X-axis as shown in FIG. 3A. In other embodiments, the flexible base region may be defined by thin areas 78 which are thinned in directions which can be defined by any combination of the X-axis, Y-axis, and Z-axis.

The flexible base region 76 has at least one cell 80. A membrane 82 is coupled over the cell 80, and again, may be deposited using MEMS techniques. One embodiment of a tunable light filter fabrication process using MEMS techniques will be discussed in more detail later in the specification. The membrane 82 may be made from Silicon-Nitride. In other embodiments, the membrane 82 may be made from materials that are transparent to the wavelengths the filter is designed to pass and have slightly tensile stress. A second mirror surface 84 is coupled to the membrane 82, and may be made from materials similar to those already discussed with respect to the first mirror surface 70.

The tunable light filter 66 also has an actuator 86 which can move the second mirror surface 84 relative to the first mirror surface 70. The actuator 86 may be mechanically, magnetically, and/or electrically coupled to the transparent plate 68 and the flexible base region. Examples of a mechanical coupling might include microactuators which change shape and/or orientation when a voltage is applied to them. Examples of a magnetic coupling might include a micro-electromagnet which can be energized to interact with either a fixed magnet and/or another electromagnet. Examples of an electrical coupling might include a bias between two parts which creates an electrostatic attraction that can be varied. As the actuator 86 moves the second mirror surface 84 relative to the first mirror surface 79, the incident light 88 will be filtered to result in output light 90 based on the spacing D between the mirror surfaces 70, 84 as previously discussed with respect to Fabry-Perot mirrors.

FIG. 3B schematically illustrates another embodiment of a tunable light filter 92. Tunable light filter 92 is similar to tunable light filter 66 from FIG. 3A, however, tunable light filter 92 from FIG. 3B has a plurality of cells 94 defined by the flexible base region 76. The plurality (two or more) of cells 94 in this embodiment enable the membrane 82 to be supported over a larger overall aperture 80. Since the view in FIG. 3B is from the side, the shape of the cells 94 can not be seen. However, the cells 94 can present a variety of shapes to the incident light 88. For example, the shapes can be square, rectangular, triangular, circular, hexoganal, etc. A particular shape may be picked for efficient packing within an overall aperture. For example, squares or rectangles pack well within a larger square. Alternatively, hexagons can pack well within a circular aperture. Each cell 94 supporting the membrane 82 can be controlled to have very good flatness over its relatively small dimensions (for example, but not limited to, 0.5 mm to 2 mm on a side, or across its diameter). Multiple cells 94 are used to provide a relatively large aperture, especially when compared to the prior art. The cell 94 walls may be formed in the flexible base region by etching away the material to expose the membrane 82. If the tunable filter 92 thus formed is placed in an optical path where there is no image formed, then the cellular structure does not interfere with image and only represents a loss of light, which would be the same as an equivalent reduction in aperture size. By having the transparent plate side facing the incoming light, any reflections off of the side of the cell walls is greatly diminished and the potential flare from that source is reduced since the cell walls are angled away from the incoming light.

FIG. 3C schematically illustrates another embodiment of a tunable light filter 96, which is similar to the filter 92 of FIG. 3B. The tunable light filter 96 of FIG. 3C, however, adds a first sensing electrode 98 and a second sensing electrode 100 which are directly or indirectly coupled to the transparent plate 68 and the flexible base region 76, respectively, such that a capacitance between the sensing electrodes 98, 100 could be measured. This measurement could be made, for example, by a controller 102 which can be coupled to the sensing electrodes 98, 100. The controller 102 can be an application specific integrated circuit (ASIC), a computer, a microprocessor, analog electronics, digital electronics, or any combination thereof. Since the capacitance between the two sensing electrodes 98, 100 will vary depending on the spacing between the electrodes 98, 100, by measuring the capacitance, the distance between the sensing electrodes 98, 100 can be determined. The spacing of the first sensing electrode relative to the transparent plate 68 can be fixed, as can the spacing of the second sensing electrode 100 relative to the flexible base 76. Similarly, the spacing of the first mirror surface 70 relative to the transparent plate 68 and the spacing of the second mirror surface 84 relative to the flexible base region 76 can be fixed. Therefore, a determination of the spacing between the sensing electrodes 98, 100 can also be a determination of the distance D between the mirror surfaces. The controller 102 can use the capacitive measurement of distance D to adjust the actuator 86 to achieve a desired pass-through setting of the tunable optical filter 96. While the embodiment of FIG. 3C schematically illustrates one actuator 86 and one pair of capacitive sensing electrodes 98, 100, other embodiments may have a plurality of actuators and/or a plurality of sensing electrodes.

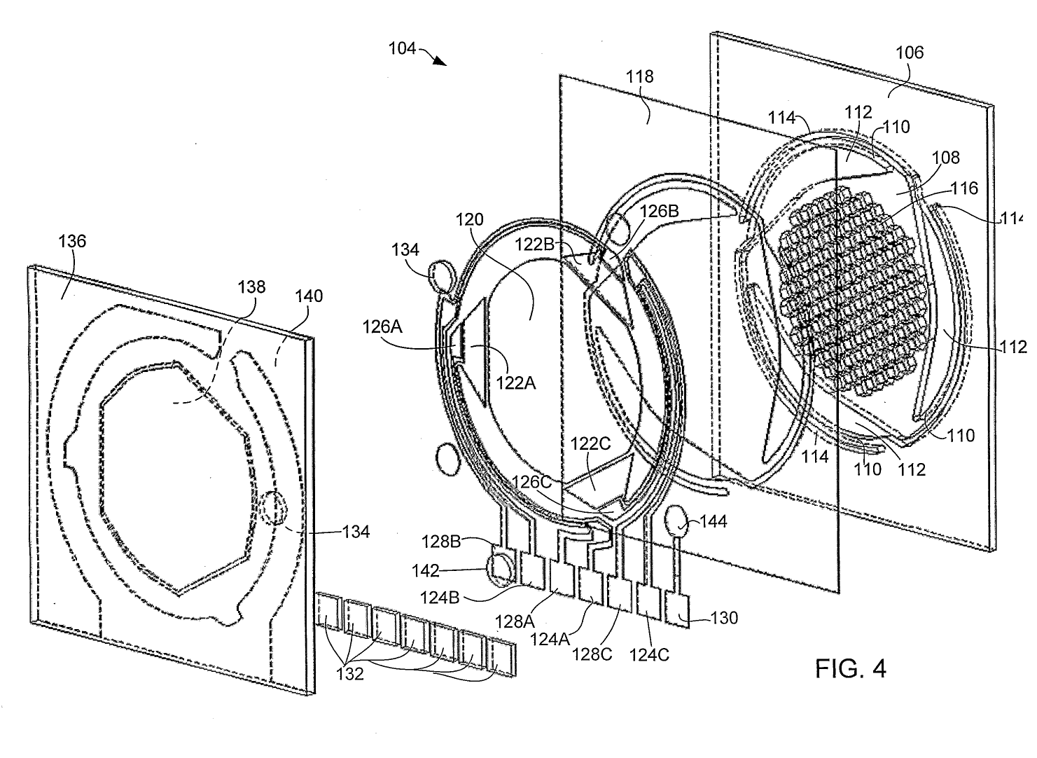

FIG. 4 illustrates an exploded perspective view of an embodiment of a tunable light filter 104. The tunable light filter 104 has a base 106 which can be made from a material such as silicon, using semiconductor fabrication techniques. While the base 106 is discussed as being silicon, other materials, or a coated silicon, for example to provide an interface for lattice matching with the silicon may be used in other embodiments, depending on various design considerations which will be apparent to those skilled in the art. The base 106 defines a flexible base region 108. The flexible base region 108 does not bend, but instead, it flexes with respect to the base 106. This is made possible in this embodiment by removing material around the flexible base region 108 so that it is only supported by thin strips 110 of silicon where it is coupled to the base 106. The thin strips 110 are defined by voids 112 and 114. A plurality of cells 116 are fabricated into the flexible base region 108. In this embodiment, the cells 116 are arranged in a honeycomb pattern.

The tunable light filter 104 also has a membrane 118. The membrane 118 when assembled, will be coupled over the cells 116 in the flexible base region 108. In this embodiment, the membrane 118 also covers the entire base 106. This can be useful, especially if the base is conductive or has been doped to be semiconductive, since electrical conductors will need to be routed throughout the device and the membrane 118, if made non-conductive, can provide electrical insulation from the base 106 and the various components which might be coupled to the base 106. An example of a suitable non-conductive membrane 118 is silicon-nitride.

The second mirror surface 120 can be coupled to the membrane 118. A suitable material for the second mirror surface 120 is silver, but other materials may be used, including a Bragg-stack mirror. In this embodiment, actuator electrodes 122A, 122B, and 122C will also be coupled to the membrane 118 aligning over at least part of the flexible base region 108. The actuator electrodes 122A, 122B, 122C are electrically connected to contact points 124A, 124B, and 124C, respectively. In this embodiment, capacitive sensing electrodes 126A, 126B, and 126C are also coupled to the membrane 118. The capacitive electrodes 126A, 126B, 126C are at least partially coupled over the flexible base region 108. The capacitive electrodes 126A, 126B, 126C are electrically connected to contact points 128A, 128B, and 128C, respectively. Although a particular connector routing and contact 124 location is shown in FIG. 4, it will be apparent that other routings and contact locations could be used in other embodiments. Ground contact 130 can be used to provide an electrical reference point versus the signals which are applied and/or measured on the other contacts.

Bond pads 132 can be coupled to the contacts 124A, 124B, 124C, 128A, 128B, 128C, and 130. Spacers 134 can also be applied at this point. The spacers 134 help determine a fixed spacing between the transparent plate (which has not been discussed yet for this embodiment) and the base 106. Finally, the tunable light filter 104 has a transparent plate 136 upon which a first mirror surface 138 is coupled, as well as an electrical reference plane 140. The electrical reference plane 140 is constructed to be in contact with the ground contact 130 via spacer 142 and contact point 144.

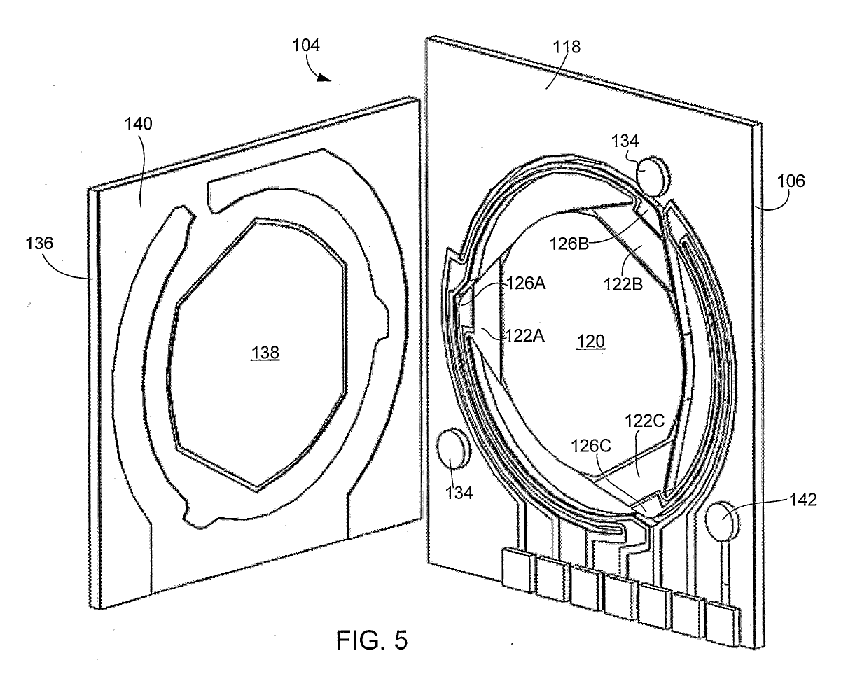

FIG. 5 illustrates an opened-up perspective view of the tunable light filter 104 embodiment from FIG. 4 when partially assembled. The transparent plate 136 has been flipped over like the page of a book versus the orientation in FIG. 4. FIG. 5 shows the electrical reference plane 140 coupled to the inside of the transparent plate 136. Examples of suitable materials for the transparent plate 136 include, but are not limited to glass and plastic. The first mirror surface 138 can also be seen coupled to the transparent plate 136. The first mirror surface 138 and the electrical reference plane 140 may be silver, but other materials may be used in other embodiments, including Brag-stack layers for the mirror. The membrane 118 is shown covering the base 106, such that the cells in the flexible base region 108 can not be seen from this view. A second mirror surface 120 covers the membrane 118 over a portion of the flexible base region 108. Actuator electrodes 122A, 122B, and 122C can also be seen in place coupled to the membrane 118. The actuator electrodes 122A, 122B, 122C will align over portions of the electrical reference plane 140 when the tunable light filter 104 is assembled. By applying voltages to the actuator electrodes 122A, 122B, and 122C in reference to the electrical reference plane 140, various electrostatic forces will be created between the actuators and the reference plane. The higher the electrostatic force, the more the actuator electrodes 122A, 122B, 122C will be attracted to the reference plane 140, and the closer that portion of the flexible base region 108 will be pulled to the reference plane 140. Capacitive electrodes 126A, 126B, and 126C can also be seen in place coupled to the membrane 118. The capacitive electrodes 126A, 126B, 126C will also align over portions of the electrical reference plane 140. By determining the distance that each capacitive electrode 126A, 126B, 126C is spaced from the electrical reference plane 140 by, those three distances can be used to calculate the planar position of the second mirror surface 120 in relation to the first mirror surface 138 as discussed above. The advantage to having three measurement points is that these three points can only determine one plane, and therefore, there are no ambiguous or conflicting solutions. Any systems with less than three measurement points would have to have at least one non-adjustable but known point, guidance for the flexible base region so that it could not tilt, or settle for the possibility of less than accurate positioning. Systems with more than three sensors and/or actuators are also possible. While such systems may be more expensive they can allow for accurate determination of planar position. Unfortunately, however, systems with more than three actuators can end up in a situation where the actuators are fighting each other for control of the planar position. In this situation, undue stress may be placed upon the flexible base region.

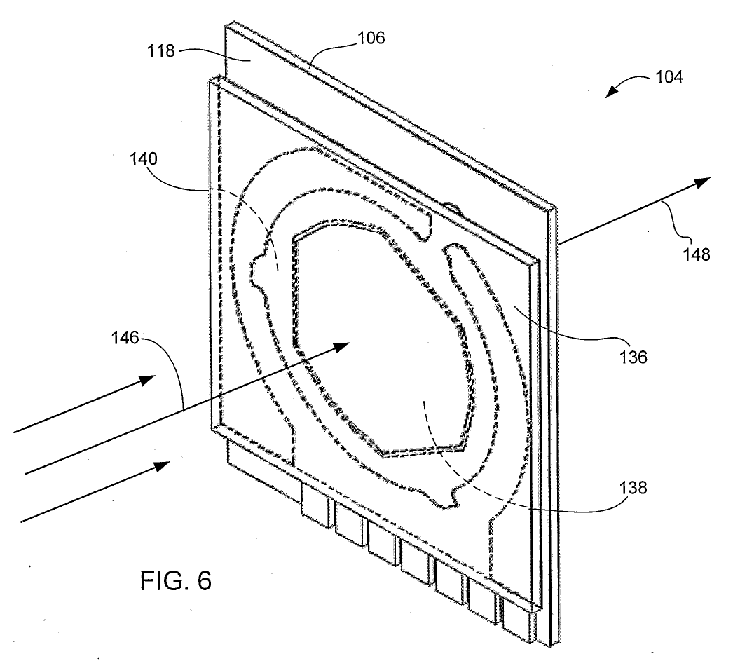

FIG. 6 illustrates an assembled perspective view of the tunable light filter 104 embodiment from FIG. 4. The tunable light filter 104 can be oriented such that incident light 146 enters through the transparent plate 136, contacts the first mirror surface 138, then the second mirror surface 120 (not visible in this view) and then according to the operation of the tunable light filter discussed previously, output light 148 will exit the filter 104 through the one or more cells 116 (also not visible in this view)

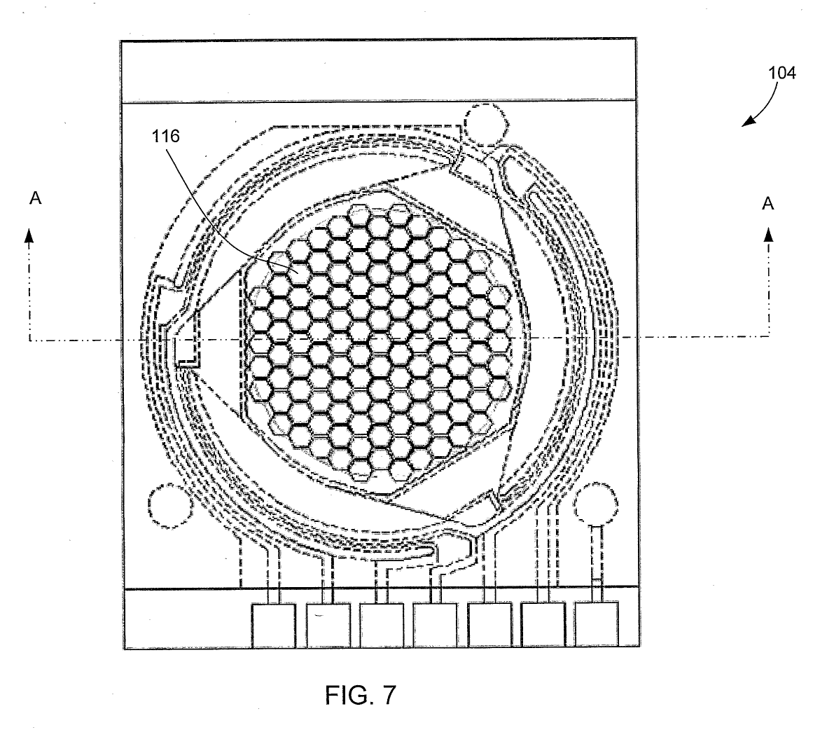

FIG. 7 illustrates a front see-through view of the tunable light filter 104 embodiment from FIG. 4 when assembled. The cells 116 are visible in this view. As was discussed before, as long as the tunable light filter 104 is placed in the optical path where no image is formed, then the pattern of cells 116 does not interfere with the image and only represents a loss of light which would be the same as an equivalent reduction in aperture size. Having a plurality of cells 116, however, does offer the advantage of providing an overall larger aperture size than the prior art (at least 10-20 mm per side or diameter range with cells of the 0.5 mm to 2 mm size) while maintaining the flatness and parallel relationship between the first and second mirror surfaces. The cells 116 can be arranged in different configurations, depending on the desired application. For example, round, square, and rectangular aperture fields are just some examples of the aperture field shapes which may be accommodated with tunable light filter 104.

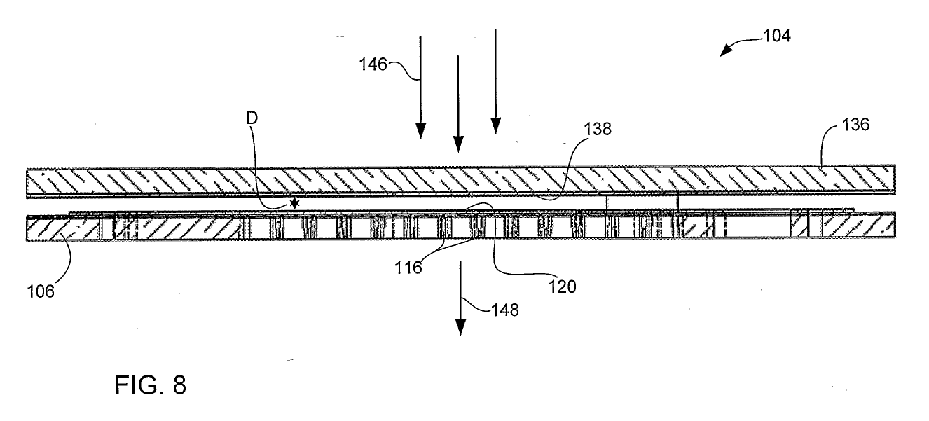

FIG. 8 illustrates a cross-sectional view of the tunable light filter embodiment from FIG. 4 when assembled as taken along cross-section line A-A from FIG. 7. Incident light 146 can be seen entering the transparent plate 136 where it will come into contact with the first mirror surface 138. Some of the light will be reflected, and some of the light will pass on to second mirror surface 120, where again, some of the light will be reflected and some will be allowed to pass. The majority of output light 148 which finally passes from the tunable light filter 104 will ideally be of a wavelength which is approximately twice the distance D which separates the two mirror surfaces 138, 120. Since the distance D is adjustable as described above, the pass wavelength is also adjustable, and therefore the tunable light filter 104 is operable.

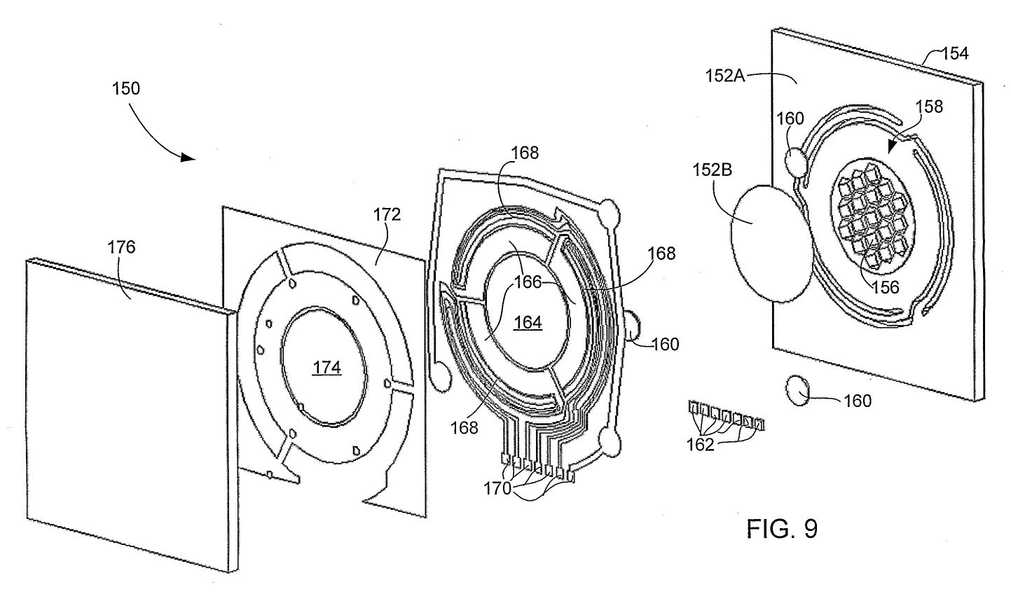

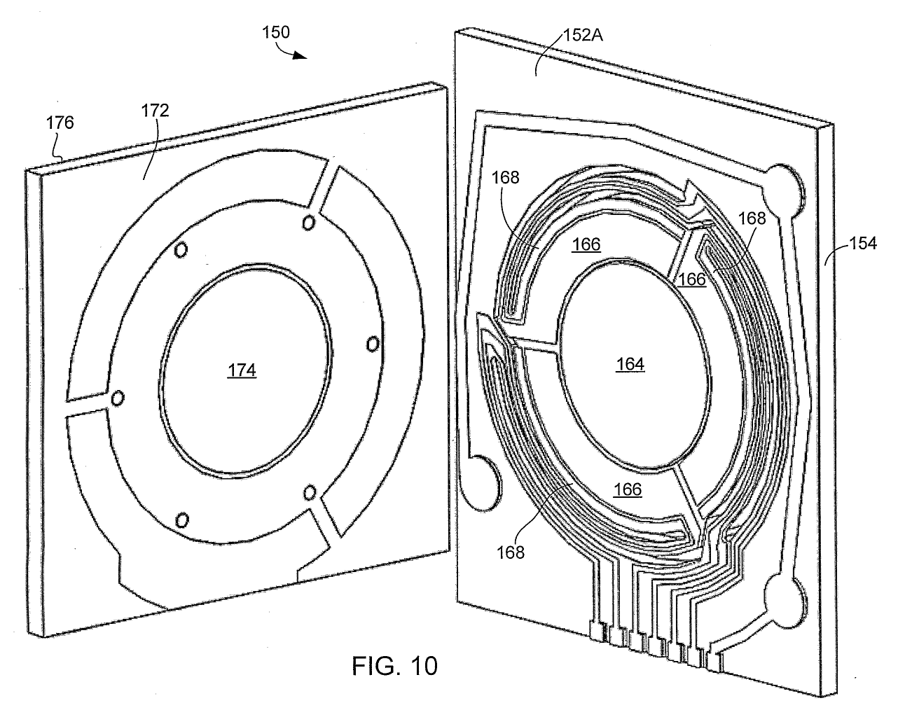

FIG. 9 illustrates an exploded perspective view of another embodiment of a tunable light filter 150. A membrane 152A is coupled to a base 154. A portion of the membrane 152A is shown exploded away (as membrane 152B) from the base 154 in order to show a plurality of cells 156 which have been formed in a flexible base region 158 of the base 154. In this embodiment, spacers 160 and bond pads 162 are formed onto the membrane 152A before any electrical connections or mirror surfaces are in place. A second mirror surface 164, a plurality of actuator electrodes 166, a plurality of capacitive sensing electrodes 168, contacts 170, and related electrical connections may then be formed onto the membrane 152A, 152B and/or any spacers or bond pads as applicable. It should be noted that this embodiment features larger actuation electrodes 166 and sensing electrodes 168 than the previous embodiment. This allows for more actuation force to be applied with a lower voltage and for more even application over a larger area. Having a larger area capacitive sensor can also allow for a larger capacitance which enables a higher resolution to the capacitance measurement, and therefore a possibly higher resolution to the distance determination. A reference plane electrode 172 and a first mirror surface 174 can be coupled to a transparent plate 176. Operation of this embodiment is similar to previous embodiments, and the main differences have been discussed. For additional perspective, however, FIG. 10 illustrates an opened-up perspective view of the tunable light filter 150 embodiment from FIG. 9 when partially assembled.

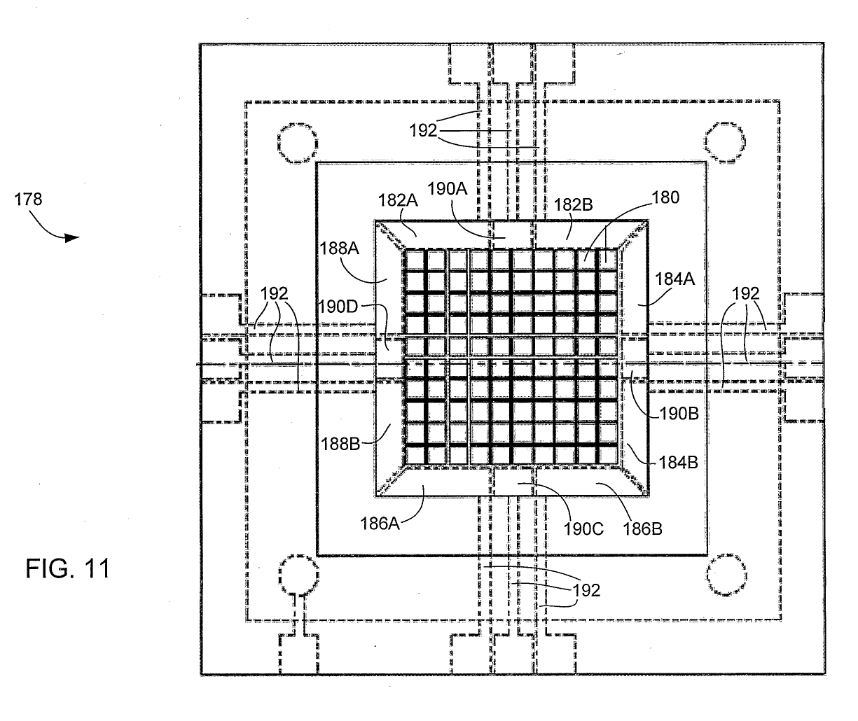

FIG. 11 illustrates a front see-through view of another embodiment of a tunable light filter 178. This embodiment has square cells 180 which are packed to fill a square aperture. The square aperture is defined in this embodiment by the actuation electrodes 182A, 182B, 184A, 184B, 186A, 186B, 188A, and 188B. Capacitive Sensors 190A, 190B, 190C, and 190D are located in the middle of each side of the aperture. The cells 180, the actuators 182, 184, 186, 188, and the sensors 190 are all located on a square flexible base region which is defined by a base and flexibly coupled to the base by supports in the middle of the square sides, as opposed to the corners in this embodiment. Connections 192 are routed over these flexible coupling points between the base and the flexible base region. Two mirror surfaces are in place as in previous embodiments, only the mirror surfaces in this embodiment are square. Since there are more than three actuating electrodes, care must be taken not to adjust the flexible base region in conflicting directions. Other embodiments with square apertures may have fewer actuators and/or sensors.

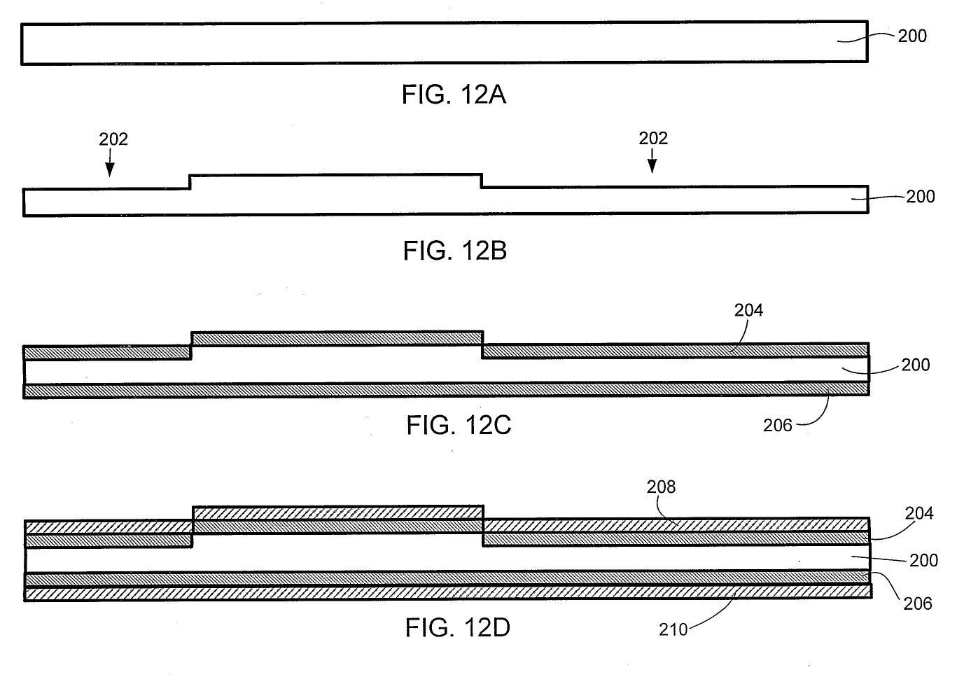

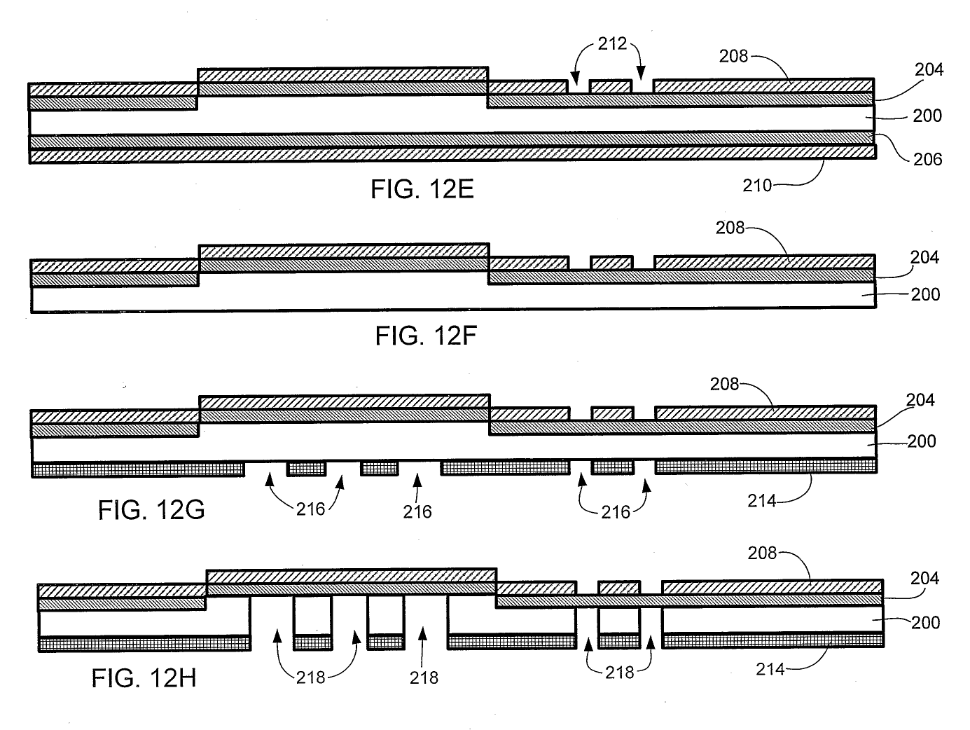

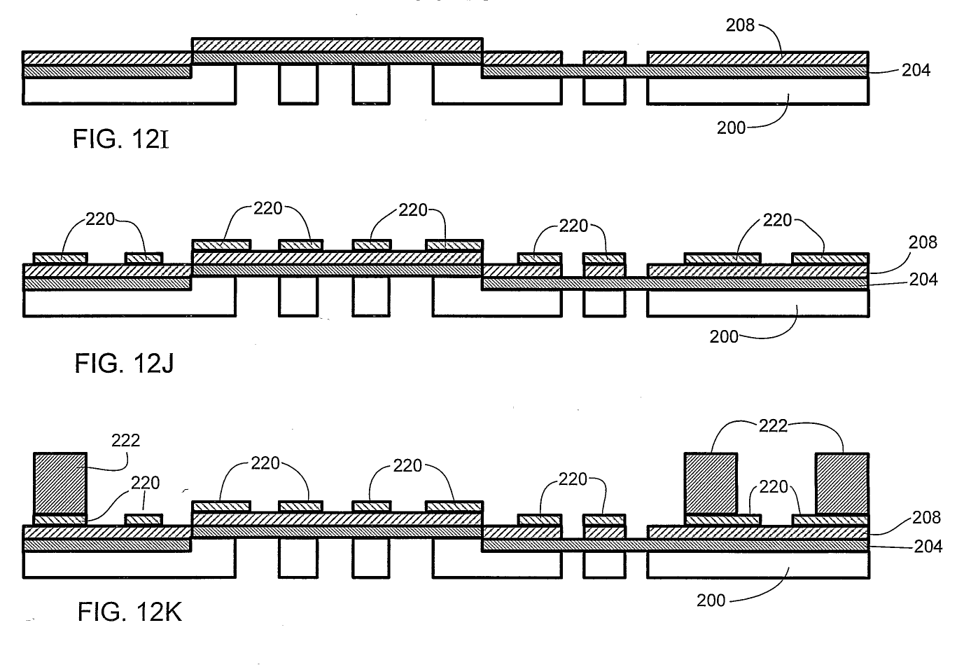

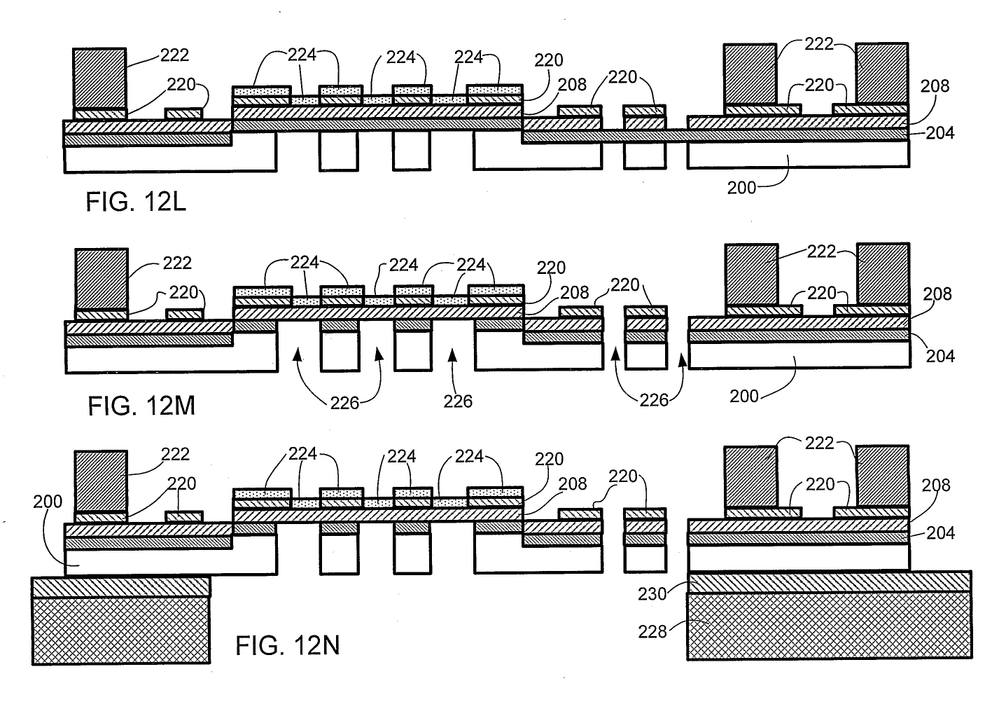

FIGS. 12A-12N, 13A-13C, and 14 schematically illustrate an embodiment of a process which may be used to fabricate a tunable light filter. Since the drawings are schematic they are not necessarily drawn to scale. Furthermore, since these process drawings are shown in cross-section, the process discussion which follows does not necessarily denote a specific embodiment of a tunable light filter being fabricated since more views would be necessary to make that specific determination. Rather, it is within the abilities of those of ordinary skill in the art to apply the process teachings herein to a desired apparatus embodiment as discussed previously, or their equivalents, and use the process steps below to create any desired tunable light filter with little or no experimentation. All dimensions given are just as examples so that one can get an idea of the possible dimensions of one embodiment. The given dimensions are not intended to be limiting in anyway. Furthermore, while some masking steps are illustrated, not all masking steps may be illustrated, as masking processes in semiconductor and MEMS fabrications are well known to those of ordinary skill in the art.

In FIG. 12A, a base 200 of bulk silicon is the starting point. The silicon base 200, for example, can be 570 microns thick, and may or may not be doped if semiconductive properties are needed in conjunction with some other semiconductor device being incorporated with the tunable light filter as an integrated MEMS device. In FIG. 12B, the silicon base 200 is etched 202, for example, to a 0.4 micron depth to make clearance for electrodes which will eventually be deposited thereon. In FIG. 12C, the base 200 is oxidized to form a protective layer of silicon-dioxide 204 on the front and a layer of silicon dioxide 206 may also be formed on the backside. In FIG. 12D, a thin layer (approx 0.2 microns) of silicon nitride 208 is formed on the front side and a thin layer of silicon nitride 210 may also be formed on the backside. The silicon nitride layers may be formed by a vapor deposition process, for example, low-pressure chemical vapor deposition. In FIG. 12E, a desired pattern is etched 212 in the silicon nitride layer 208 on the front side. The etched pattern can correspond to any areas where it is not desired to have the silicon-nitride membrane covering. For example, it can be desirable to etch away the membrane over where the voids in the base will be made to define the flexible base region. In FIG. 12F, the backside silicon-nitride layer 210 and the backside silicone dioxide layer 206 are removed from the base 200, for example, by a chemical etch process. In FIG. 12G, a hard mask 214 is deposited and etched 216 on the backside. In FIG. 12H, the base 200 is etched 218 through to the silicon dioxide layer 204 from the backside where the hard mask 214 has left the base exposed. A deep reactive ion etching process may be used for this. This deep etch through the silicon base 200 can be used to define the flexible base region, as well as the cells within the flexible base region. In FIG. 12I, the hard mask 214 is removed. In FIG. 12J, aluminum electrodes 220 are deposited onto the silicon nitride membrane 208. Some of the electrodes 220 may be used as actuators. Some may be used as capacitive sensors. Some may provide reference plane connections, and others may provide support for spacers. In FIG. 12K, spacers 222, for example made out of aluminum, 0.9 microns thick, are deposited on or coupled to some of the electrodes 220. In FIG. 12L, a mirror surface 224, such as a silver, is deposited on and/or coupled to the electrodes 220 and/or the silicon nitride membrane 208 in at least an aperture region. If desired, to alleviate stress between the lattice structure of the silver and the material below it, a titanium seed layer may first be grown where the mirror surface will later be. At this point in the fabrication process, assuming batch semiconductor and/or MEMS processes are being used, the chips may be diced from the fabrication wafers. In FIG. 12M, the silicon dioxide layer 204 which is exposed to the backside is removed 226. In FIG. 12N, a package 228, such as a ceramic package with a ground conductor 230, can be coupled to the base 200.

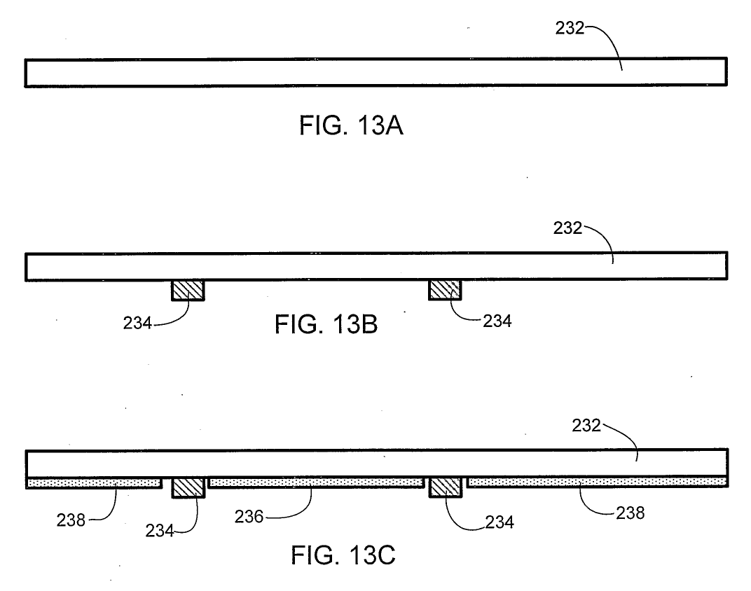

In a separate and/or parallel process, a transparent plate 232 is started with, such as the transparent plate 232 schematically illustrated in FIG. 13A. The transparent plate can be made of glass, for example, 675 microns thick. In FIG. 13B, bumps 234 can be coupled to the transparent plate 232. The bumps 234 act as a safety to prevent the effective areas of mirror surfaces from contacting each other. It is useful to be able to prevent the two smooth mirror surfaces from being able to contact each other, since if they contact each other, they may actually bond together and not be separable. In FIG. 13C, another mirror surface 236 and reference plane electrodes 238 may be coupled to the transparent plate 232. The mirror surface 236 can, for example, be formed of silver, 40 microns thick. The reference plane electrodes may be similarly formed.

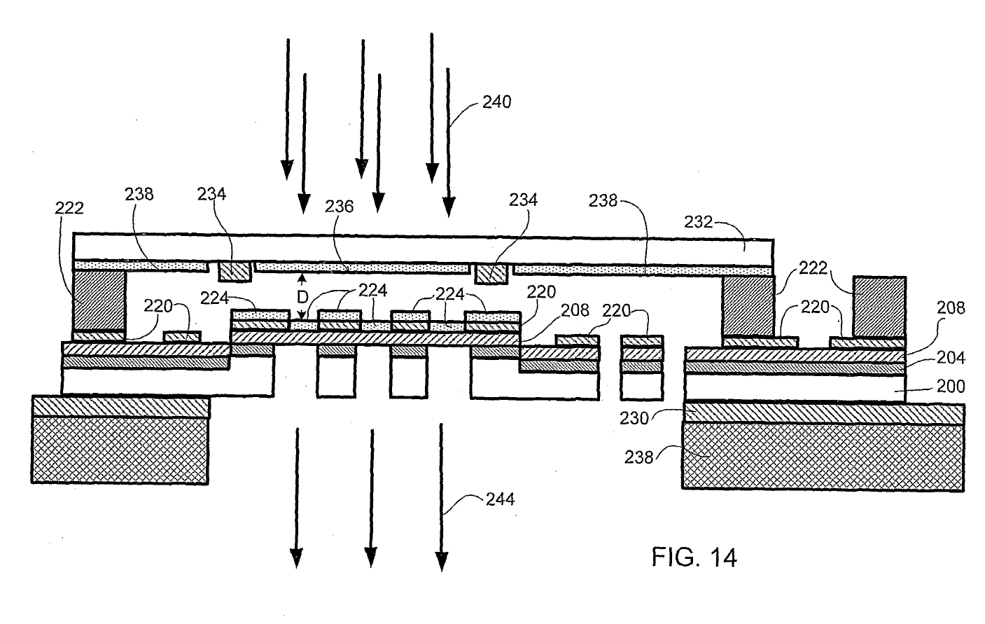

Finally, the assembly illustrated in FIG. 12N may be coupled to the assembly illustrated in FIG. 13C as schematically illustrated in FIG. 14. For reference, incident light 240 is shown entering the tunable light filter through the transparent plate 232, where some of the light will be reflected by the first mirror surface 236 and some will pass through. Of the light which passes through the first mirror surface 236, some will be reflected by second mirror surface 224 and some will be allowed to pass through the cells 242 covered by membrane 208. The light which passes through the cells 242 as defined by the base 200, after passing through the second mirror surface 224 can be referred to as output light 244. As discussed previously, the wavelength of the majority of the output light should be approximately equal to twice the distance D which separates the two mirror surfaces 236, 224.

Having thus described several embodiments of the claimed invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A tunable light filter, comprising:
a transparent plate;
a first mirror surface coupled to the transparent plate;
a base spaced from the transparent plate and defining a flexible base region, wherein the flexible base region comprises:
at least one cell;
a membrane coupled over the at least one cell; and
a second mirror surface coupled to the membrane; and
an actuator which can move the second mirror surface relative to the first mirror surface.

2. The tunable light filter of claim 1, wherein the transparent plate comprises glass.

3. The tunable light filter of claim 1, wherein the transparent plate comprises plastic.

4. The tunable light filter of claim 1, wherein the transparent plate comprises quartz.

5. The tunable light filter of claim 1, wherein the first mirror surface comprises silver.

6. The tunable light filter of claim 1, wherein the first mirror surface comprises a Bragg-stack.

7. The tunable light filter of claim 1, wherein the base comprises silicon.

8. The tunable light filter of claim 7, wherein the silicon comprises a semiconductive doping agent.

9. The tunable light filter of claim 1, wherein the flexible base region comprises a substantially square shape.

10. The tunable light filter of claim 1, wherein the flexible base region comprises a substantially circular shape.

11. The tunable light filter of claim 1, wherein the flexible base region comprises a substantially triangular shape.

12. The tunable light filter of claim 1, wherein the flexible base region is coupled to the base by three contact points.

13. The tunable light filter of claim 12, wherein each of the three contact points have a height relative to the transparent plate which is adjustable by the actuator.

14. The tunable filter of claim 12, wherein at least one of the three contact points has a height relative to the transparent plate which is adjustable by the actuator.

15. The tunable light filter of claim 1, wherein the flexible base region is coupled to the base by at least one contact point which has a height relative to the transparent plate which is adjustable by the actuator.

16. The tunable light filter of claim 1, wherein the flexible base region comprises at least two cells.

17. The tunable filter of claim 16, wherein the cells have a shape selected from the group consisting of circles, squares, triangles, hexagons, octagons, and rectangles.

18. The tunable light filter of claim 16, wherein the cells are placed in the unfocused light path of an optic system.

19. The tunable light filter of claim 1, wherein the membrane is substantially non-conductive.

20. The tunable light filter of claim 1, wherein the membrane is further coupled over the flexible base region.

21. The tunable light filter of claim 20, wherein the membrane is further coupled over the base.

22. The tunable light filter of claim 1, wherein the membrane comprises silicon nitride.

23. The tunable light filter of claim 1, wherein the second mirror surface comprises silver.

24. The tunable light filter of claim 23, wherein the second mirror surface further comprises a seed layer between the membrane and the silver.

25. The tunable light filter of claim 24, wherein the seed layer comprises titanium.

26. The tunable light filter of claim 1, wherein the second mirror surface comprises a Bragg-stack.

27. The tunable light filter of claim 1, wherein the actuator comprises an electrostatic actuator.

28. The tunable light filter of claim 27, wherein the electrostatic actuator comprises:
an actuator electrode coupled directly or indirectly to the flexible base region;
a reference plane electrode coupled to the transparent plate at least partially aligned with the actuator electrode; and
such that when a voltage is applied to the actuator electrode relative to the reference plane electrode, an electrostatic force is created between the electrodes, whereby the electrostatic force can affect a spacing between the first mirror surface and the second mirror surface by moving the flexible base region relative to the transparent plate.

29. The tunable light filter of claim 28, wherein the membrane is coupled between the actuator electrode and the flexible base region.

30. The tunable light filter of claim 1, wherein the actuator is selected from a group consisting of an electrical actuator, a mechanical actuator, an electro-mechanical actuator, a magnetic actuator, and an electro-magnetic actuator.

31. The tunable light filter of claim 1, wherein the transparent plate comprises a partially transparent plate.

32. The tunable light filter of claim 1, further comprising:
a capacitive sensor configured to be coupled to a processor for determining the spacing between the first mirror surface and the second mirror surface.

33. An optical device, comprising:
at least one optical input;
at least one optical output; and
a tunable light filter; comprising:
a transparent plate configured to receive the at least one optical input;
a first mirror surface coupled to the transparent plate;
a base spaced from the transparent plate and defining a flexible base region, wherein the flexible base region comprises:
at least one cell;
a membrane coupled over the at least one cell; and
a second mirror surface coupled to the membrane and configured to output light to the at least one optical output; and
an actuator which can move the second mirror surface relative to the first mirror surface such that the majority of light passing to the optical output has a wavelength which is approximately twice a distance between the first mirror surface and the second mirror surface as set by the actuator.

34. The optical switching device of claim 33, wherein the optical output comprises a light sensor.

35. The optical device of claim 33, wherein the optical device is selected from the group consisting of a telescope, a microscope, and interferometer, a spectrometer, a fiber optic switch, and an optical multiplexer.

36. A method of manufacturing a tunable light filter, comprising:
coupling a first mirror surface to a transparent plate;
forming a flexible base region in a base;
forming at least one cell in the flexible base region;
coupling a membrane over the at least one cell;
coupling a second mirror surface to the membrane over the at least one cell; and
coupling the transparent plate to the base such that the first mirror surface and the second mirror surface are adjustably spaced apart, substantially parallel to each other, and such that they at least partially overlap.

37. A method of manufacturing a tunable light filter, comprising:
etching a silicon base;
oxidizing the silicon base;
forming a silicon nitride membrane over the oxidized silicon base;
etching a pattern in the silicon nitride membrane;
removing silicon nitride and silicon dioxide from a backside of the silicon base;
depositing and etching a hard mask on the backside of the silicon base;
deep reactive ion etching the backside of the silicon base through the hard mask to at least define a flexible base region and at least one cell within the flexible base region;
removing the hard mask;
coupling aluminum electrodes to the silicon nitride membrane;
coupling aluminum spacers to the aluminum electrodes;
forming a first silver mirror surface on a transparent plate;
forming a second silver mirror surface on the silicon nitride membrane over the at least one cell;
coupling the transparent plate to the silicon base such that the first mirror surface and the second mirror surfaces are adjustably spaced apart, substantially parallel to each other, and such that they at least partially overlap.
